(19) United States
(12) Patent Application Publication
(10) Pub. No.: US 2002/0051089 A1
(43) Pub. Date: May 2, 2002

(54) Image display apparatus

(76) Inventors: Akira Arimizu, Kagoshima (JP); Shigeto Nishijima, Kagoshima (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 09/845,168

(22) Filed: May 1, 2001

(30) Foreign Application Priority Data
May 2, 2000 (JP) P2000-133458

(51) Int. Cl. H04N 5/21; H04N 5/202

(52) U.S. Cl. 348/674; 348/625

(57) ABSTRACT

When a display image is a photographic image or a moving image, an ON signal is inputted from the ON-OFF circuit and the ON-OFF circuit to the sharpness circuit and the gamma correction circuit under a control signal from the control circuit. An inputted image signal Fc is subjected to sharpness processing for edge enhancement by the sharpness circuit, and the intermediate signal level of the image signal Fc is raised by gamma correction of the gamma correction circuit. Thus, the CRT can display a sharp, high-quality photographic or moving image having an enhanced edge and emitting light with its luminance proportional to the signal level. When a display image is a code display image of letters or the like, the sharpness circuit is controlled to be in an unactivated state and the gamma correction circuit is controlled to be in an activated state under a control signal from the control circuit. Thus, the CRT can display a sharp code image having light emission characteristics proportional to the signal level of an inputted image signal Fc.

### BACKGROUND OF THE INVENTION

The present invention relates to an image display apparatus for displaying an image of an image signal outputted from a computer, for example.

Configuration of a conventional image display apparatus is as shown in FIG. 5. An image signal Fc from a computer or the like is inputted to an amplifier circuit unit 6 comprising a preamplifier 7 and a main amplifier 8 via a switch 15 turned to a switch terminal t2 side, for example, to be subjected to amplification and waveform shaping by the amplifier circuit unit 6. The image signal Fc outputted from the amplifier circuit unit 6 is scanned over a display screen of a CRT 5 under an output signal of a deflection processing circuit 3 operated under an inputted deflection control signal Fd, whereby the CRT 5 displays an image of the inputted image signal Fc. In this case, when the switch 15 is turned to a switch terminal ti side, a sharpness circuit 1 subjects the image signal Fc to sharpness processing for edge enhancement, and then the image signal Fc after subjected to the sharpness processing is inputted to the CRT 5, whereby the CRT 5 displays an image resulting from the sharpness processing for edge enhancement.

When a code image is to be displayed by using a word processor or a spreadsheet program, edge enhancement by the sharpness circuit 1 may result in a blurred, unclear image of letters or ruled lines, and therefore the switch 15 is turned to the switch terminal t2 side to display the image.

With the widespread use of DVD (Digital Versatile Disc), there have been increasing cases where an accurate, high-quality image based on an image signal such as a moving image or a photograph is displayed. In such cases, it is necessary to make gamma correction for correcting level of a signal corresponding to intermediate luminance level of the display image in order to sharpen an image in the intermediate luminance region.

Thus, when the display image is to be subjected to gamma correction, it is necessary to use a computer with a built-in gamma correction function, for example.

### SUMMARY OF THE INVENTION

The present invention has been made in view of the above-mentioned current conditions of image display involving moving images and photographic images, and it is accordingly an object of the present invention to provide an image display apparatus capable of performing proper image processing according to the type of the display image.

According to an aspect of the present invention, there is provided an image display apparatus comprising: image signal processing means having a gamma correction circuit for correcting level of a signal corresponding to intermediate luminance level of a display image and a sharpness circuit for performing sharpness processing to enhance an edge of the display image; image processing control means for controlling image processing operation of the image signal processing means such that at least either one of the gamma correction circuit and the sharpness circuit of the image signal processing means is selected so as to subject the display image to image processing by the selected circuit, or neither of the gamma correction circuit and the sharpness circuit is selected so as not to subject the display image to image processing of the image signal processing means; and display means for displaying the image processed by signal processing of the image signal processing means or the image not subjected to signal processing of the image signal processing means under control of the image processing control means.

With this configuration, the image display apparatus is provided with image signal processing means having a gamma correction circuit for correcting level of a signal corresponding to intermediate luminance level of a display image and a sharpness circuit for performing sharpness processing to enhance an edge of the display image; and image processing control means for controlling the image signal processing means such that at least either one of the gamma correction circuit and the sharpness circuit is selected so as to subject the display image to at least either of gamma correction processing and sharpness processing, or neither of the gamma correction circuit and the sharpness circuit is selected so as not to subject the display image to gamma correction processing nor sharpness processing. Therefore, it is possible to perform proper image processing according to the type of the display image and to thereby display a sharp, high-quality image processed according to the type of the display image by display means.

According to the above invention, there may be provided an image display apparatus, wherein when the display image is a code display image, the image processing control means controls signal processing operation of the image signal processing means such that the gamma correction circuit is selected, or neither of the gamma correction circuit and the sharpness circuit is selected.

With this configuration, when the display image is a code display image, the image processing control means controls signal processing operation of the image signal processing means such that the gamma correction circuit is selected, or neither of the gamma correction circuit and the sharpness circuit is selected. Therefore, it is possible for the display means to display the code display image of letters, figures, symbols, ruled lines or the like without the image being blurred by the sharpness circuit.

According to the above invention, there may be provided an image display apparatus, wherein when the display image is a photographic image or a moving image, the image processing control means controls signal processing operation of the image signal processing means such that the gamma correction circuit and the sharpness circuit are selected.

With this configuration, when the display image is a photographic image or a moving image, the image processing control means controls the signal processing operation of the image signal processing means such that the gamma correction circuit and the sharpness circuit are selected. Therefore, it is possible to subject intermediate luminance level of the photographic image or the moving image to gamma correction, and it is thereby possible for the display means to display a sharp, high-quality photographic or moving image having luminance proportional to the signal level of the image.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a block diagram showing a configuration of a first embodiment of the present invention;

FIG. 2 is a schematic diagram for illustrating sharpness image processing according to the first embodiment;

FIG. 3 is a schematic diagram for illustrating gamma correction image processing according to the first embodiment;

FIG. 4 is a block diagram showing a configuration of a second embodiment of the present invention; and

FIG. 5 is a block diagram showing a configuration of a conventional image display apparatus.

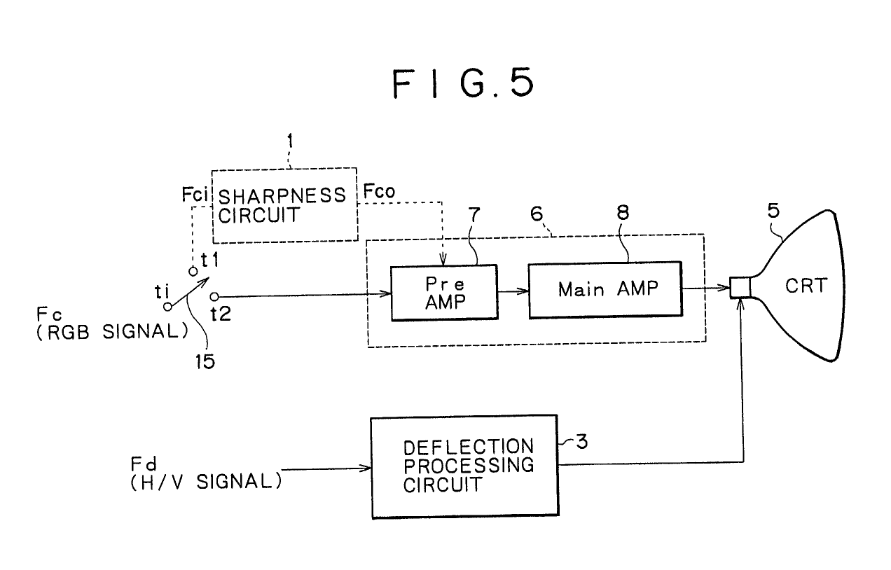

### DETAILED DESCRIPTION OF PREFERRED EMBODIMENTS

[First Embodiment]

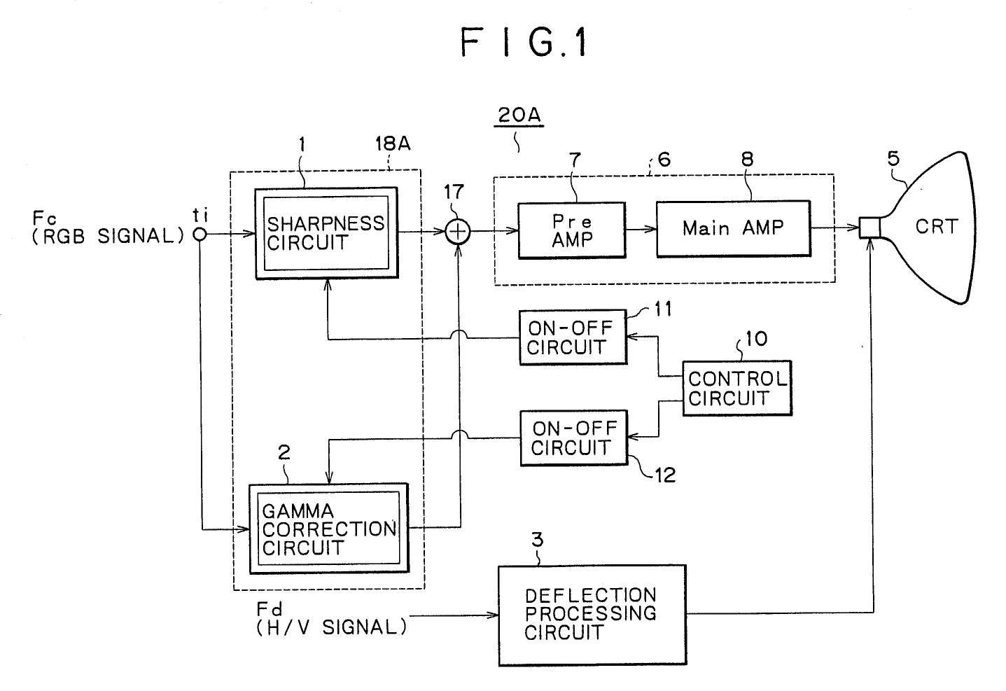

A first embodiment of the present invention will be described with reference to FIGS. 1 to 3.

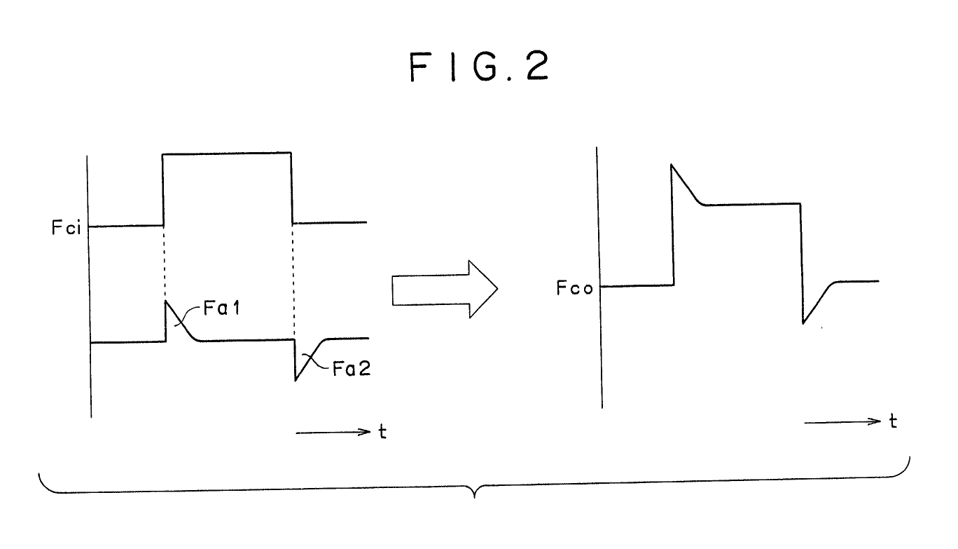

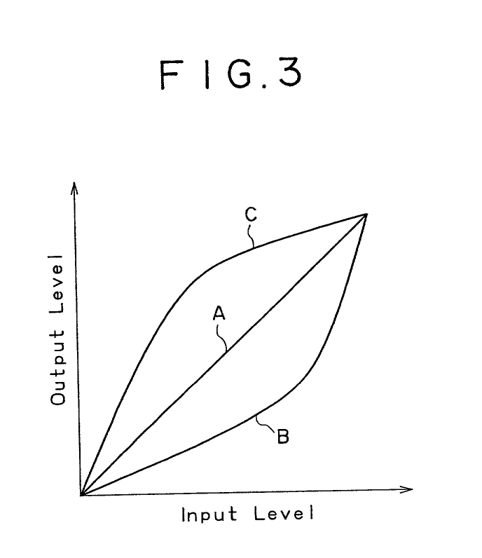

FIG. 1 is a block diagram showing a configuration of the first embodiment. FIG. 2 is a schematic diagram for illustrating sharpness image processing according to the first embodiment. FIG. 3 is a schematic diagram for illustrating gamma correction image processing according to the first embodiment.

As shown in FIG. 1, an image display apparatus 20A according to the first embodiment is provided with an image processing unit 18A that has a sharpness circuit 1 and a gamma correction circuit 2 in parallel with each other connected to an input terminal ti. An output terminal of the sharpness circuit 1 and an output terminal of the gamma correction circuit 2 are connected to an input terminal of an adder 17. An output terminal of the adder 17 is connected to a preamplifier 7, and an output terminal of the preamplifier 7 is connected to a main amplifier 8. The preamplifier 7 and the main amplifier 8 comprise an amplifier circuit unit 6.

An output terminal of the main amplifier 8 is connected to an input terminal of a CRT 5. An output terminal of a deflection processing circuit 3 supplied with a deflection control signal Fd is connected to a deflecting coil of the CRT 5. Incidentally, the input terminals and the output terminals described above each comprise three terminals: an R signal terminal (red signal terminal), a G terminal (green signal terminal), and a B terminal (blue signal terminal).

The first embodiment is further provided with a control circuit 10 for controlling operation of the image processing unit 18A. One output terminal of the control circuit 10 is connected to the sharpness circuit 1 via an ON-OFF circuit 11, while the other output terminal of the control circuit 10 is connected to the gamma correction circuit 2 via an ON-OFF circuit 12.

Operation of the first embodiment thus formed will be described.

According to the first embodiment, when an image signal Fc inputted from the input terminal ti is a photographic image or a moving image, an ON signal is inputted from the ON-OFF circuit 11 to the sharpness circuit 1 under a control signal from the control circuit 10, and at the same time, an ON signal is inputted from the ON-OFF circuit 12 to the gamma correction circuit 2 under a control signal from the control circuit 10.

Thus, the sharpness circuit 1 and the gamma correction circuit 2 are brought into an activated state. As shown in FIG. 2, in accordance with time axis t, correction signals Fa1 and Fa2 are then formed at a rising edge and a falling edge, respectively, of an image signal Fci inputted to the sharpness circuit 1. An image signal Fco obtained by superimposing the correction signals Fa1 and Fa2 on the input image signal Fci is outputted from the sharpness circuit 1 to one input terminal of the adder 17.

Characteristics of output light emission luminance of the CRT 5 with respect to a signal level corresponding to luminance of the input signal are those as indicated by a curve B in FIG. 3. Therefore, in order to change the characteristics of light emission luminance of the CRT 5 into linear characteristics as indicated by a straight line A in FIG. 3 with respect to the level of the input signal, the gamma correction circuit 2 subjects an intermediate level of the signal to gamma correction as indicated by a curve C in FIG. 3.

The gamma correction circuit 2 has a function of carrying out signal conversion so as to provide characteristics as indicated by the curve C in FIG. 3 between the input signal level corresponding to the luminance of the inputted image signal Fci and an output signal level. The gamma correction circuit 2 thus raises the intermediate level of the image signal as indicated by the curve C, whereby the characteristics of light emission luminance of the CRT 5 obtained by an output image signal of the gamma correction circuit 2 become linear with respect to the signal level of the input image as indicated by the straight line A in FIG. 3.

Thus, the image signal Fco obtained by sharpness processing for edge enhancement by the sharpness circuit 1 and gamma correction by the gamma correction circuit 2 is outputted from the adder 17, then amplified by the preamplifier 7, and thereafter subjected to amplification and waveform shaping processing by the main amplifier 8. The resulting signal is inputted to the CRT 5 to be scanned over a display plane of the CRT 5 by the deflecting coil excited by an output signal of the deflection processing circuit 3. Thus, the CRT 5 displays a sharp, high-quality display image having an enhanced edge and emitting light with its luminance proportional to the signal level.

On the other hand, when an image signal Fc inputted from the input terminal ti represents a code display frame of letters, figures, symbols, ruled lines or the like, an OFF signal is inputted from the ON-OFF circuit 11 to the sharpness circuit 1 under a control signal from the control circuit 10, and at the same time, an ON signal is inputted from the ON-OFF circuit 12 to the gamma correction circuit 2 under a control signal from the control circuit 10. In this case, the sharpness circuit 1 is brought into an unactivated state because a code image of letters, figures, symbols, ruled lines or the like subjected to sharpness processing may result in a blurred display image.

Thus, in this case, only the gamma correction circuit 2 is in an activated state. The adder 17 outputs an image signal Fco obtained by gamma correction, and then the amplifier circuit unit 6 amplifies and shapes the outputted image signal, so that the image signal with its intermediate signal level raised by level correction is inputted to the CRT 5. Therefore, light emission characteristics proportional to the level of the input signal can be obtained, and thus an unblurred, sharp code image can be displayed.

As described above, according to the first embodiment, when an image to be displayed is a photographic image or a moving image, an ON signal is inputted from the ON-OFF circuit 11 to the sharpness circuit 1 under a control signal from the control circuit 10, and at the same time, an ON signal is inputted from the ON-OFF circuit 12 to the gamma correction circuit 2 under a control signal from the control circuit 10. An inputted image signal Fi is subjected to sharpness processing for edge enhancement by the sharpness circuit 1 and to gamma correction for raising the intermediate signal level of the image signal Fi by the gamma correction circuit 2. Thus, the CRT 5 can display a sharp, high-quality photographic or moving image having an enhanced edge and luminance proportional to the signal level.

On the other hand, when an image to be displayed is a code display frame of letters, figures, symbols, ruled lines or the like, an OFF signal is inputted from the ON-OFF circuit 11 to the sharpness circuit 1 under a control signal from the control circuit 10, and at the same time, an ON signal is inputted from the ON-OFF circuit 12 to the gamma correction circuit 2 under a control signal from the control circuit 10. The intermediate signal level of an inputted image signal Fi is raised by level correction. Thus, the CRT 5 can display a sharp code image having luminance proportional to the signal level.

[Second Embodiment]

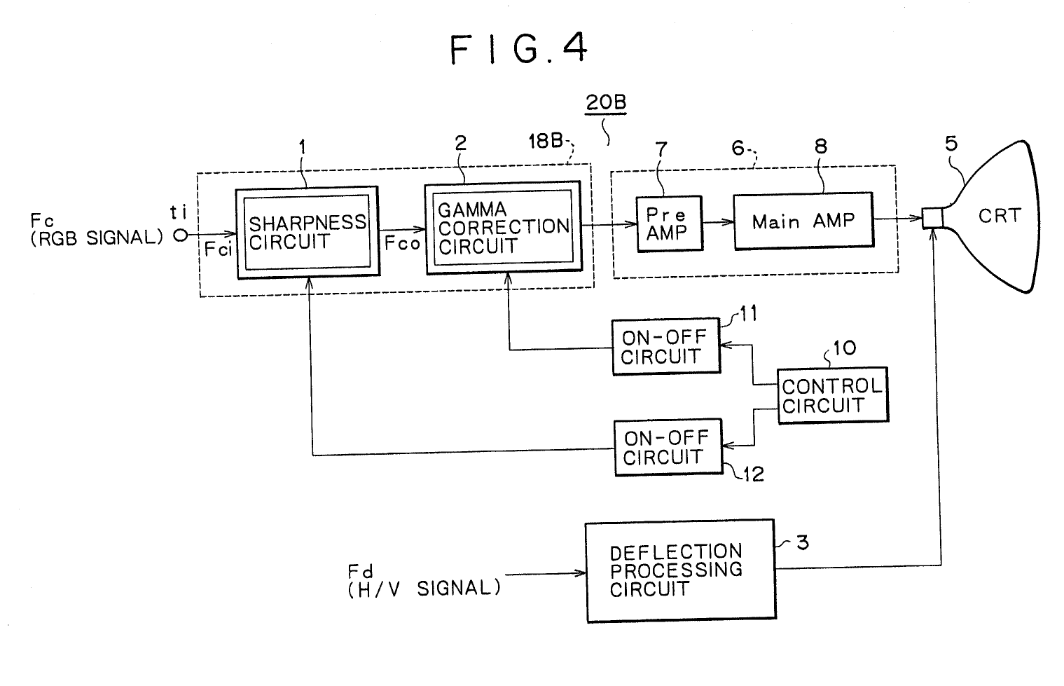

A second embodiment of the present invention will be described with reference to FIG. 4.

FIG. 4 is a block diagram showing a configuration of the second embodiment.

As shown in FIG. 4, an image display apparatus 20B according to the second embodiment is provided with an image processing unit 18B formed by connecting a gamma correction circuit 2 to an output terminal of a sharpness circuit 1, and an output terminal of the gamma correction circuit 2 is connected directly to an input terminal of a preamplifier 7 in an amplifier circuit unit 6. When the sharpness circuit 1 and the gamma correction circuit 2 are in an unactivated state, the sharpness circuit 1 and the gamma correction circuit 2 output an image signal Fc as it is without performing any processing.

Configuration and operation of the other parts of the second embodiment are the same as those of the first embodiment described above, and therefore their repeated description will be omitted.

The second embodiment not only has the effects obtained by the first embodiment described above but also eliminates the need for the adder 17 in the first embodiment, thereby making it possible to reduce the number of parts and to simplify and miniaturize the configuration of the second embodiment.

As described above, when the first embodiment displays a code image, the control circuit 10 effects control so as to bring the sharpness circuit 1 into an unactivated state and bring the gamma correction circuit 2 into an activated state, whereby the display image is subjected to only gamma correction and thus a sharp code image is displayed. However, the present invention is not limited to the first embodiment; the control circuit 10 may effect control so as to bring both the sharpness circuit 1 and the gamma correction circuit 2 into an unactivated state so that the CRT 5 displays an unblurred code image.

In addition, description has been made of the second embodiment formed by connecting the gamma correction circuit 2 at a stage subsequent to the sharpness circuit 1. However, the present invention is not limited to the second embodiment; the sharpness circuit 1 may be connected at a stage subsequent to the gamma correction circuit 2.

While a preferred embodiment of the present invention has been described using specific terms, such description is for illustrative purposes only, and it is to be understood that changes and variations may be made without departing from the spirit or scope of the following claims.

What is claimed is:

1. An image display apparatus comprising:
image signal processing means having a gamma correction circuit for correcting level of a signal corresponding to intermediate luminance level of a display image and a sharpness circuit for performing sharpness processing to enhance an edge of said display image;
image processing control means for controlling image processing operation of the image signal processing means such that at least either one of said gamma correction circuit and said sharpness circuit of the image signal processing means is selected so as to subject said display image to image processing by the selected circuit, or neither of said gamma correction circuit and said sharpness circuit is selected so as not to subject said display image to image processing of said image signal processing means; and
display means for displaying the image processed by signal processing of said image signal processing means or the image not subjected to signal processing of said image signal processing means under control of the image processing control means.

2. An image display apparatus as claimed in claim 1, wherein when said display image is a code display image, said image processing control means controls signal processing operation of said image signal processing means such that said gamma correction circuit is selected, or neither of said gamma correction circuit and said sharpness circuit is selected.

3. An image display apparatus as claimed in claim 1, wherein when said display image is a photographic image or a moving image, said image processing control means controls signal processing operation of said image signal processing means such that said gamma correction circuit and said sharpness circuit are selected.
